(19) United States
(12) Patent Application Publication
(10) Pub. No.: US 2024/0326198 A1
(43) Pub. Date: Oct. 3, 2024

(54) COMPACT ADJUSTABLE SPRAY NOZZLE TO PRECISELY TARGET AREAS FOR RINSING, REMOVING PARTICLES, AND IMPROVE HARDWARE CLEANLINESS

(71) Applicant: Applied Materials, Inc., Santa Clara, CA (US)

(72) Inventors: Shaun VAN DER VEEN, Santa Clara, CA (US); Edward L. FLOYD, Santa Clara, CA (US); Haosheng WU, Fremont, CA (US)

(21) Appl. No.: 18/128,555

(22) Filed: Mar. 30, 2023

(51) Int. Cl. B24B 57/02; B05B 1/00

(52) U.S. Cl. CPC B24B 57/02; B05B 1/00

(57) ABSTRACT

Embodiments of the present disclosure generally relate fluid nozzles used in semiconductor manufacturing. The fluid nozzle includes a nozzle body disposed between an inlet face and an outlet face. The body includes a threaded region, a central symmetric axis, and a port. The threaded region is disposed between the inlet face and the outlet face. The central symmetric axis extends along a port axis and through the nozzle body. The port extends along a port axis and through the nozzle body. The port axis extends through the nozzle body between the inlet face and the outlet face. A first angle is formed between the port axis and the central symmetric axis. A port outlet face is perpendicular to the port axis, adjacent to the outlet face, and at a second angle to the outlet face.

### BACKGROUND

### Field

Embodiments of the present invention generally relate to a nozzle, and more specifically to an adjustable substrate processing tool nozzle for use in semiconductor processing.

### Description of the Related Art

An integrated circuit is typically formed on a substrate by the sequential deposition of conductive, semi conductive, or insulative layers on a silicon substrate. Fabrication includes depositing a filler layer over a non-planar surface, and planarizing the filler layer until the non-planar surface is exposed. A conductive filler layer can be deposited on a patterned insulative layer to fill trenches or holes in the insulative layer. The filler layer is then polished until the raised pattern of the insulative layer is exposed. After planarization, the portions of the conductive filler layer remaining between the raised pattern of the insulative layer form vias, plugs, and lines that provide conductive paths between thin film circuits on the substrate. In addition, planarization may be needed to planarize a dielectric layer at the substrate surface for photolithography.

Chemical mechanical polishing (CMP) is one accepted method of planarization. This planarization method includes mounting the substrate on a carrier head or polishing head of a CMP apparatus. The exposed surface of the substrate is placed against a rotating polishing disk pad or belt pad. The carrier head provides a controllable load on the substrate to urge the device side of the substrate against the polishing pad. A polishing slurry, including at least one chemically-reactive agent, and abrasive particles if a standard pad is used, is supplied to the surface of the polishing pad.

The substrate is typically retained below the carrier head against a membrane within a retaining ring. Moreover a gap is present between an outer edge of the substrate and an inner perimeter of the retaining ring when the substrate is in the carrier head. In addition, a gap is present between an outer edge of the membrane and an inner perimeter of the retaining ring. These gaps and other areas proximate to the outer edge of the substrate can accumulate polishing slurry and organic residues during processing. These residues can remain on the substrate edge and/or dislodge during processing and cause defects to the substrate and affect the efficiency of the CMP apparatus. These gaps have a different location depending on the various cleaning apparatuses. Thus, there is a need for an apparatus that can be adjusted for different sizes and configurations.

### SUMMARY

In one embodiment, a fluid nozzle is provided. The fluid nozzle includes a nozzle body disposed between an inlet face and an outlet face. The body includes a threaded region, a central symmetric axis, and a port. The threaded region is disposed between the inlet face and the outlet face. The central symmetric axis extends along a port axis and through the nozzle body. The port extends along a port axis and through the nozzle body. The port axis extends through the nozzle body between the inlet face and the outlet face. A first angle is formed between the port axis and the central symmetric axis. A port outlet face is perpendicular to the port axis, adjacent to the outlet face, and at a second angle to the outlet face.

In another embodiment, a fluid nozzle is provided. The fluid nozzle includes a nozzle body disposed between an inlet face and an outlet face. The body includes a threaded region, a securing region, a central symmetric axis, and a port. The threaded region is disposed adjacent to the inlet face. The securing region is disposed between the outlet face and the threaded region. The central symmetric axis extends through the nozzle body between the inlet face and the outlet face. The port extends along a port axis and through the nozzle body. The port axis extends through the nozzle body between the inlet face and the outlet face. A first angle is formed between the port axis and the central symmetric axis. A port outlet face includes an outlet, is perpendicular to the port axis, adjacent to the outlet face, and at a second angle to the outlet face.

In another embodiment, a fluid nozzle is provided. The fluid nozzle includes a nozzle body disposed between an inlet face and an outlet face. The body includes a threaded region, a central symmetric axis, and a port. The threaded region is disposed between the inlet face and the outlet face. The central symmetric axis extends through the nozzle body between the inlet face and the outlet face. The port extends along a port axis and through the nozzle body. The port axis is parallel to and offset from the central symmetric axis. The port axis extends through the nozzle body between the inlet face and the outlet face. The port has a port outlet face perpendicular to the port axis and adjacent to the outlet face.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of the scope of the disclosure, as the disclosure may admit to other equally effective embodiments.

FIG. 1 depicts a top, plan view of a chemical mechanical polishing (CMP) system according to an embodiment.

FIG. 2A depicts a partial side view of a carrier head according to an embodiment.

FIG. 2B depicts a bottom view of the carrier head of FIG. 2A according to an embodiment.

FIG. 3A depicts a top, plan view of a load cup according to an embodiment.

FIG. 3B depicts a schematic side view of a spray pattern for a nozzle according to an embodiment.

FIGS. 4A, 4B, 4C, and 4D depict schematic side views of nozzles according to some embodiments.

FIG. 5 depicts a schematic side view of a nozzle according to an embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure relates to an adjustable fluid nozzle configured to remove debris from a substrate carrier head, specifically remove debris from a gap in the carrier head. The cleaning can take place while the substrate is in the carrier head, before the substrate is loaded into the carrier head, or after the substrate is unloaded from the carrier head.

The adjustable fluid nozzle has characteristics that are favorable for penetrating and effectively cleaning narrow gaps in the carrier head between a hydrophobic membrane and an inner perimeter of a retaining ring of the carrier head. The adjustable fluid nozzle is configured to direct a fluid stream by setting an orientation of the nozzle. One example of a favorable characteristic is that the nozzle is able to maintain a steady stream of fluid at standard operating conditions. According to one or more embodiments of the disclosure, the adjustability of the nozzle allows for a broad range of sprayer and carrier head combinations.

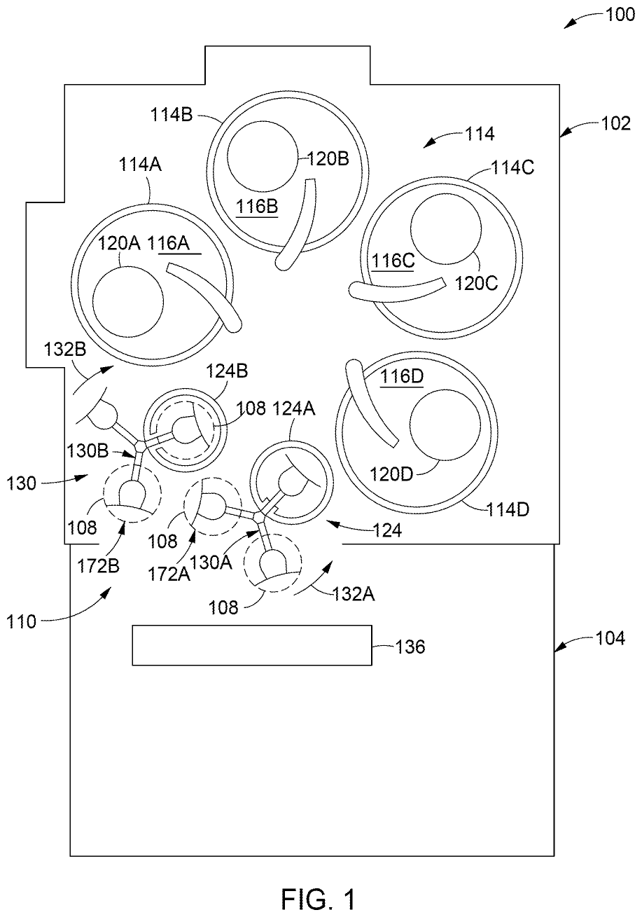

FIG. 1 depicts a top, plan view of a chemical mechanical polishing (CMP) system 100 according to an embodiment disclosed herein. Although a CMP system is illustrated in FIG. 1 and described herein, the concepts disclosed herein may be applied to other substrate processing devices. The CMP system 100 includes a polishing section 102 and a cleaning and drying section 104 that process (e.g., wash and/or polish) substrates 108. The CMP system 100 includes other sections that perform other processes on the substrates 108. As used herein, substrates include articles used to make electronic devices or circuit components. Substrates include semiconductor substrates such as silicon-containing substrates, patterned or unpatterned substrates, glass plates, masks, and the like. A pass-through 110 is an opening between the polishing section 102 and the cleaning and drying section 104 that accommodates the transfer of the substrates 108.

The polishing section 102 includes one or more polishing stations 114, such as individual polishing stations 114A-114D. Each of the polishing stations 114 include a polishing pad, such as individual polishing pads 116A-116D. The polishing pads rotate against surfaces of the substrates 108 to perform various polishing processes. One or more slurries (not shown) are applied between the substrate 108 and the polishing pad 116A-116D to process the substrate.

The polishing section 102 includes a plurality of carrier heads 120 that maintain the substrates 108 against the polishing pads 116A-116D during polishing. Each of the polishing stations 114A-114D may include a single head, such as individual carrier heads 120A-120D. The carrier heads 120A-120D secure the substrates 108 therein as the carrier heads 120A-120D are transported to and from the polishing stations 114A-114D. For example, the carrier heads 120A-120D secure the substrates 108 therein as the carrier heads 120A-120D are transported between load cups 124 (e.g., individual load cups 124A, 124B) and the polishing stations 114A-114D. The load cups 124A, 124B transport the substrates 108 between the carrier heads 120A-120D and substrate exchangers 130 (e.g., individual exchangers 130A, 130B). A first substrate exchanger 130A rotates in a first direction 132A and a second exchanger 130B rotates in a second direction 132B, which may be opposite or the same as the first direction 132A.

The cleaning and drying section 104 includes a robot 136 that transfers the substrates 108 through the pass-through 110 to and from the substrate exchangers 130A, 130B at various access locations 172A, 172B. The robot 136 also transfers the substrates 108 between stations (not shown) in the cleaning and drying section 104 and the substrate exchangers 130A, 130B.

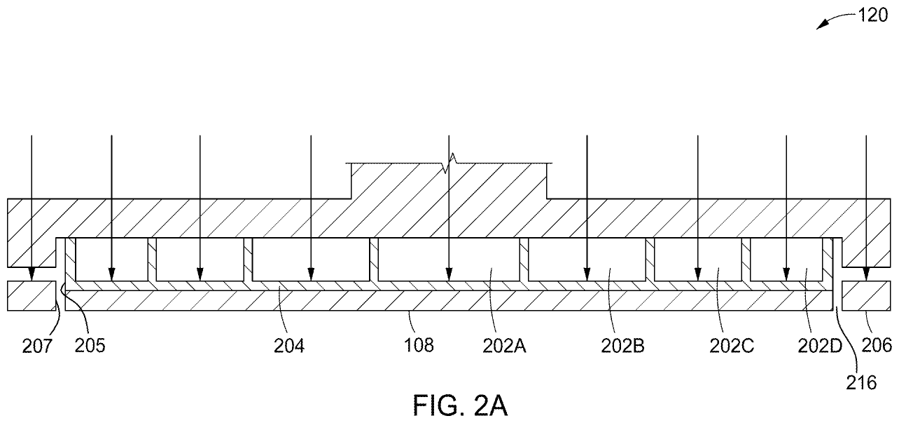

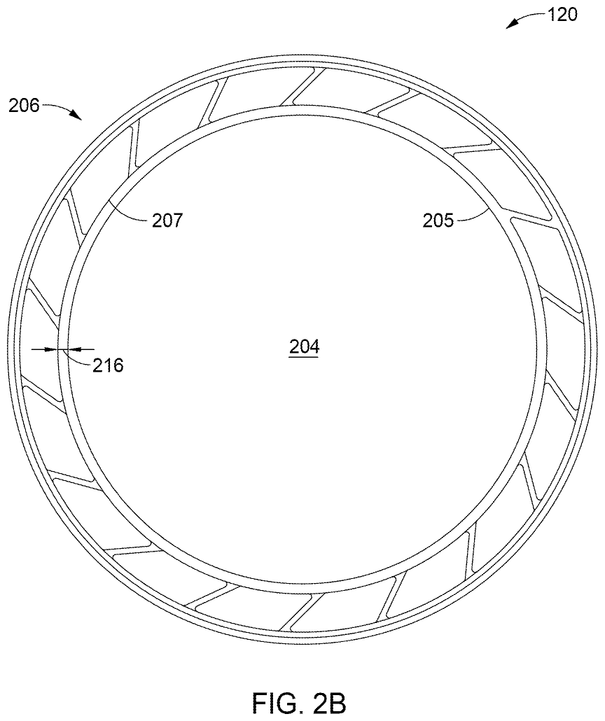

FIGS. 2A and 2B depict a side view and a bottom view of the carrier head 120 according to some embodiments, which can be any of carrier heads 120A-120D in FIG. 1. The carrier head 120 includes a retaining ring 206 to retain the substrate 108 below a membrane 204. The membrane 204 is a flexible, hydrophobic membrane 204. The membrane 204 has an outer perimeter 205 that is surrounded by an inner perimeter 207 of the retaining ring 206. A gap 216 is formed between the inner perimeter 207 of the retaining ring 206 and the outer perimeter 205 of the membrane 204. In some embodiments, the gap 216 is about 0.5 mm to about 3 mm, such as about 1 mm to about 2 mm. The carrier head 120 includes one or more independently controllable pressurizable chambers 202 defined by the membrane 204. During processing, as the carrier head 120 rotates the substrate 108 while pressing it against the polishing pad 116 (FIG. 1), polishing slurry, debris, and residue can accumulate on the substrate 108 edge, the inner perimeter 207, the substrate bevel areas, and other locations such as within the gap 216. The residue and particles can build up over time and be released during processing potentially causing scratches on the substrate 108.

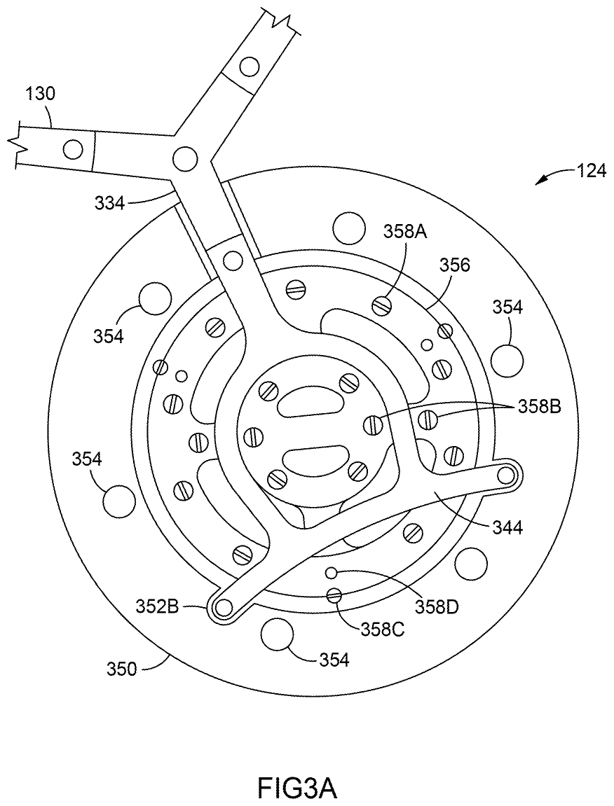

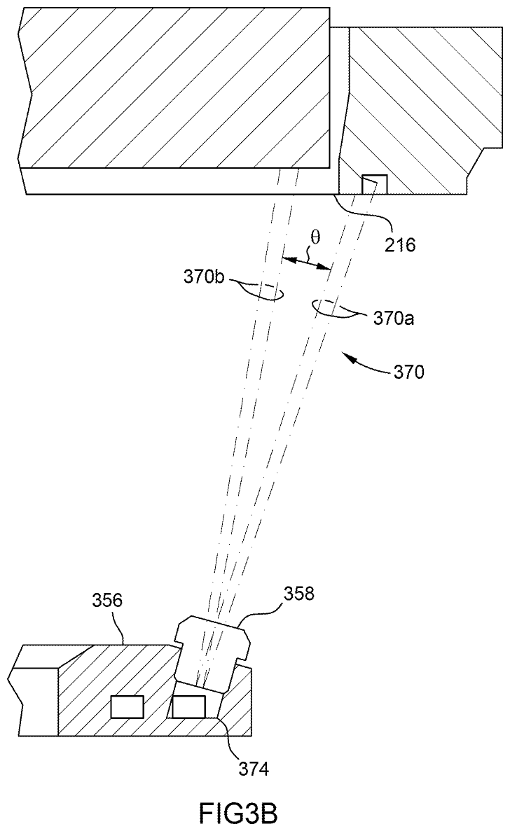

FIG. 3A depicts a top, plan view of the load cup 124 (e.g., 124A or 124B) according to an embodiment. The load cup 124 includes a substrate station 350 that has an annular shape. The substrate station 350 moves vertically to place substrates 108 onto a blade 334 of the substrate exchanger 130 (e.g., 130A, 130B) and to remove the substrates 108 from the blade 334. The blade 334 is rotatable to the access location 172A, 172B for loading and unloading of the substrate 108 by the robot 136 (FIG. 1).

The substrate station 350 includes notches (e.g., 352A, 352B, 352C) to receive the blade 334. The substrate 108 rests on raised features of the substrate station 350. As the substrate station 350 moves in an upward direction and removes the substrate 108 from the blade 334, the substrate 108 is positioned within a plurality of pins 354, which create a pocket to center the substrate 108.

The load cup 124 includes a sprayer 356 having a plurality of various nozzles (e.g., 358A, 358B, 358C, 358D) configured to spray fluids (e.g., deionized water) onto the blade 334, a substrate 108 (not shown in FIG. 3A) on the blade 334, a substrate on the carrier head 120, and/or a carrier head 120 (not shown in FIG. 3A) located above the load cup 124. The sprayer 356 includes a set of first nozzles 358A disposed around the outer portion of the sprayer 356, for example, to rinse the substrate 108, and a set of second nozzles 358B disposed in an array along a diameter of the sprayer 356, for example, to rinse the membrane 204 of the carrier head 120, when respectively positioned over the load cup 124. The sprayer 356 includes a set of third nozzles 358C on the outer portion of the sprayer 356 configured to spray portions of the carrier head 120, such as the gap 216 between the outer perimeter 205 of the membrane 204 and the inner perimeter 207 of the retaining ring 206, when the carrier head 120 is positioned over the load cup 124, with or without the substrate 108. The third nozzles 358C (e.g., spray nozzles) are also configured to spray an outer edge of the substrate 108, while retained in the carrier head 120, such as a gap between the outer edge of the substrate 108 and the inner perimeter 207 of the retaining ring 206. The third nozzles 358C are coupled to a rinse solution, such as deionized water at room temperature, such as about 10° C. to about 40° C. Each of the third nozzles 358C are coupled to atomizers. The fourth set of nozzles 358D are disposed proximate to each third nozzle 358C on an upper surface of the sprayer 356 at an outer portion of the sprayer 356.

FIG. 3B depicts a partial cross section of the sprayer 356 with a nozzle 358. The nozzle 358 according to some embodiments is configured to spray a stream 370 of fluid at the gap 216. The nozzle 358 can be rotated to adjust the stream 370 by an angle θ. The stream 370 has first end of adjustment 370a to a second end of adjustment 370b such that the stream 370 can target the gap 216 within the range defined by the angle θ. In other words the stream 370 can target the gap 216 when the gap 216 is anywhere between the first end of adjustment 370a to a second end of adjustment 370b. The stream 370 has a diameter between about 2 mm and 5 mm, for example 3 mm. The nozzle 358 is adjusted by screwing the nozzle 358 into the sprayer 356. The nozzle 358 receives the fluid by an internal channel 374 within the sprayer 356. The internal channel 374 and the fluid is at a pressure between about 1 psi and about 80 psi, for example about 40 psi. The flow rate through the internal channel 374 is between about 1 liters/minute (L/min) to about 3 L/min, for example about 2 L/min. The nozzles 358 have a flowrate of fluid through them between about 2 liters/minute (L/min) to about 5 L/min, for example about 3 L/min. The pressure is tunable to achieve desirable stream characteristics. The stream 370 is a laminar flow of fluid capable of spraying the gap 216 when the nozzle 358 is at a distance between about 50 mm to 200 mm away from the gap 216. The nozzle 358 is adjusted to the distance the stream 370 needs to travel by selecting the correct nozzle 358 size, adjusting the stream pressure, and also is dependent on the fluid used in the stream 370. The stream 370 according to some other embodiments may have a cone shape, a square shape, and/or a flat fan shape. The sizing and adjustability of the nozzle 358 is discussed further, below.

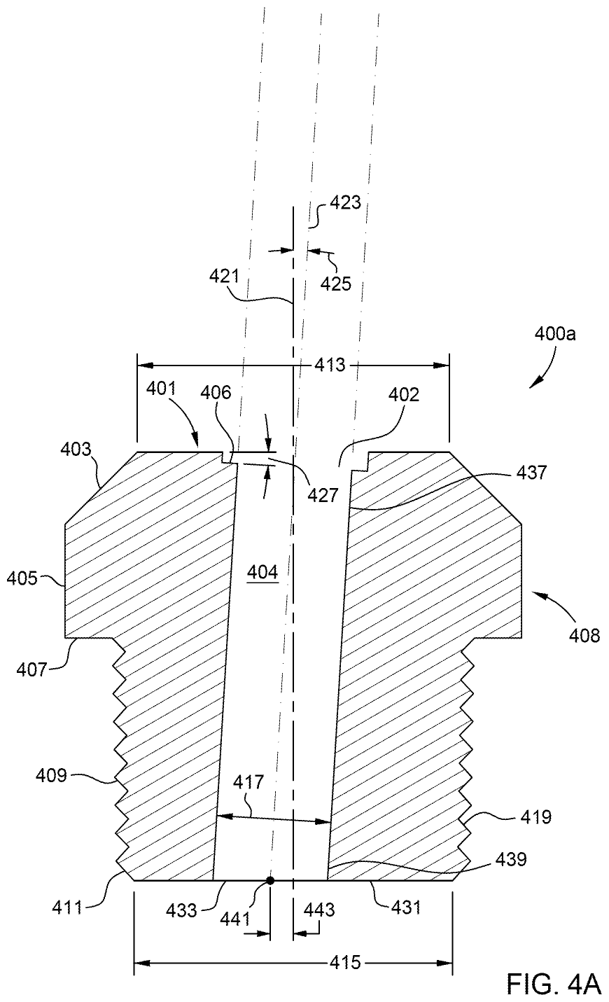

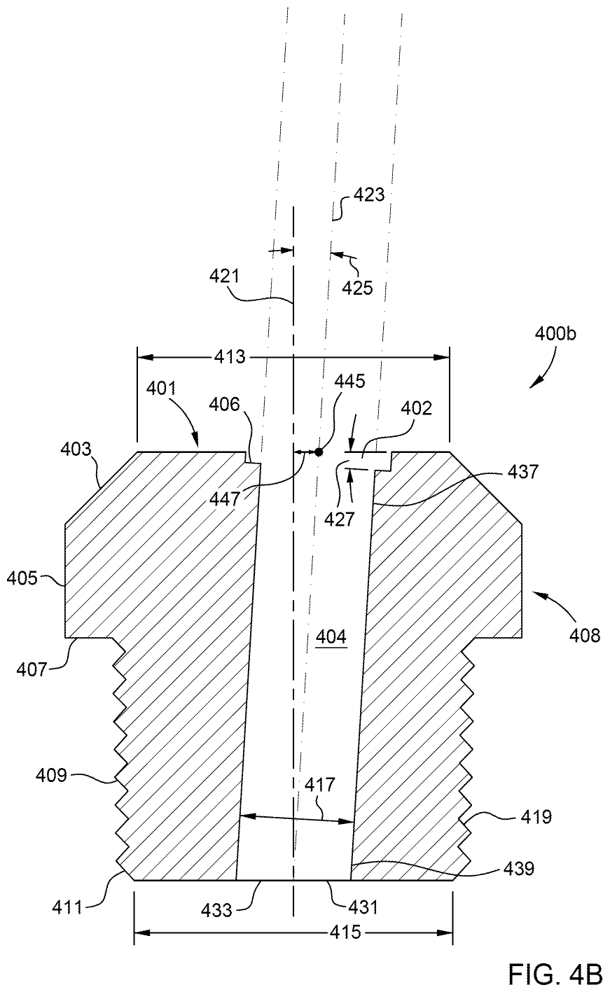

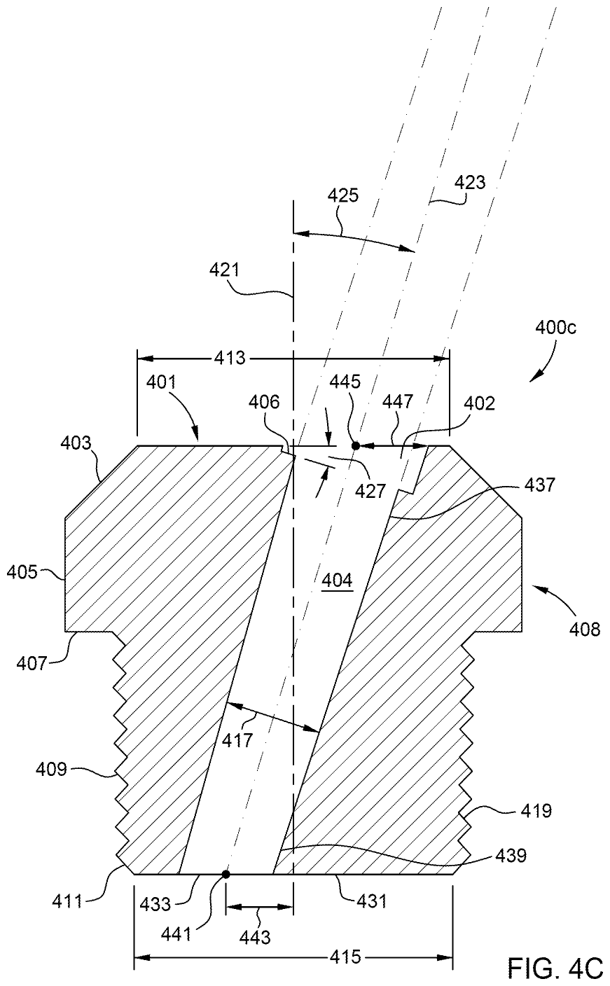

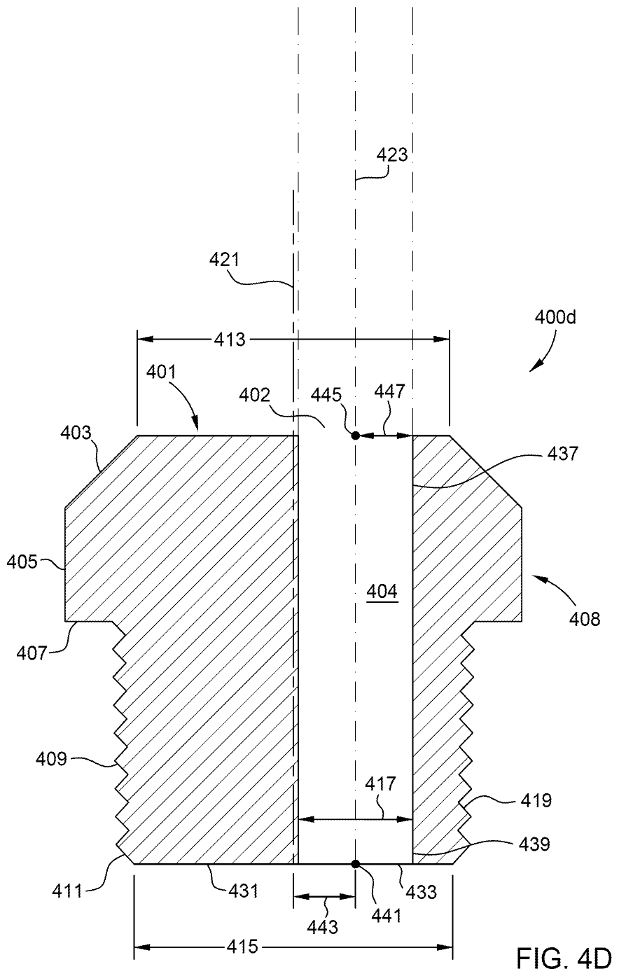

FIGS. 4A, 4B, 4C, and 4D depict cross sections of some embodiments of the nozzle 358, illustrated as nozzle 400 (400a, 400b, 400c, and 400d). In the following description, the reference number “400” is used when referring to all of nozzles “400a”, “400b”, “400c”, and “400d”. The nozzle 400 includes an outlet face 401 with a port outlet 402 and an inlet face 431. The outlet face 401 has an outlet face diameter 413 between about 3 mm and about 17 mm, for example between 10 mm and about 31 mm, in yet another example, about 8 mm. The inlet face 431 has an inlet face diameter 415 between 3 mm and about 17 mm, for example between 10 mm and about 31 mm, in yet another example, about 8 mm. The fluid nozzle 400 also includes a nozzle body 407 disposed between the inlet face 431 and the outlet face 401 of the nozzle 400. The body 407 includes a threaded region 409, a central symmetric axis 421 extending through the nozzle body 407, and a port 404 extending through the body 407. The body 407 may comprise any one of PEEK (Polyetheretherketone), brass, stainless steel, and/or PVDF (Poly-vinylidene-fluoride). The body 407 may also comprise any other non-metal-contaminating material. In some embodiments, the nozzle 400 may also include an O-ring adjacent to the threaded region 409 and a securing region 408. The securing region 408 of the nozzle 400 includes a securing feature 405. The securing feature 405 operates as a depth stop when tightening the nozzle 400 into the sprayer 356. The securing feature 405 also includes a way to secure the nozzle 400. In some embodiments the securing feature 405 is a 7/16 hex pattern disposed along the edges of the body 407 enabling the nozzle 400a to be tightened into the sprayer 356. In other embodiments other sizes and pattern are contemplated, for example a 9/16 hex pattern and/or a square pattern. In other embodiments the securing feature 405 is knurling disposed on the exterior of the body 407 that enables the nozzle 400a to be tightened and secured into the sprayer 356 without the need for tools, i.e. tool-less rotation. The threaded region 409 is located between the inlet face 431 and the securing feature 405.

The central symmetric axis 421 extends through the center of the nozzle body 407 between the inlet face 431 and an outlet face 401. The port 404 extends along a port axis 423 and through the nozzle body 407 between the inlet face 431 and the outlet face 401. According to some embodiments, the nozzle 400 also includes a first angle 425 formed between the port axis 423 and the central symmetric axis 421. The port 404 includes a port outlet face 406 within the port outlet 402. The port outlet face 406 is perpendicular to the port axis 423 and adjacent to the outlet face 401, and at a second angle 427 to the outlet face 401.

Traditional nozzle designs limited the sprayer 356 to specific carrier heads 120 held at specific heights. The improved adjustable nozzle 400 described herein allows for multiple carrier head 120 and sprayer 356 combinations in a single substrate station 350 to be used by simply tuning the nozzle 400 through a rotation and stream 370 pressure adjustment. Previously, if the alignment was not perfect, the operating conditions were not tuned, and/or the height of the carrier head 120 was not within a certain range, the stream 370 would be unable to target the gap 216 and/or the stream 370 would not be laminar.

The nozzle 400 described herein is able to be tuned to the specific apparatus within which it is installed. For example, in some embodiments where the first angle 425 is 5° the an angle θ is equal to about 10° and gives the nozzle 400 a target range of about 2 mm to about 25 mm of adjustability to target specific areas of the carrier head 120. The outlet port face 406 also aids in maintaining laminar flow from the stream 370 buy being perpendicular to the port axis 423.

The threaded region 409 of the nozzle 400a includes threads 419 and is located between the inlet face 431 and the securing feature 405. For example, the threaded region may be between about 0.2″ and about 0.4″. The threads 419 of the threaded region 409 are standard thread patterns, for example the threads may be ⅛″ NPT threads, ¼″ NPT threads, and/or ½″ NPT threads, but other sizes are contemplated. The nozzle 400a may also include an alignment feature 411. The alignment feature 411 as shown in a chamfer between the inlet face 431 and the threaded region 409 that helps align and center the nozzle 400a during installation. The threads 419 of the threaded region enable the nozzle 400 to only require one full rotation to be secured in the sprayer 356, but may be rotated more, for example three rotations to be secured in the sprayer. The nozzle 400 may be rotated additional rotations to adjust the nozzle 400 such that the nozzle 440 targets, for example, the gap 216 of the carrier head 120.

The port 404 of the nozzle 400 has a port diameter 417. The port diameter 417 is between about 0.3 mm and about 2.5 mm, for example 1 mm. The port 404 is a hole along the port axis 423 through the nozzle 400, starting at the port inlet 433 and ending at the port outlet 402. The port outlet 402 includes the port outlet face 406. The port outlet face 406 is perpendicular to the port axis 423 to ensure uniform flow. While illustrated as a circular port 404, in other embodiments the port 404 may have different shapes such that the nozzle 400 produces the stream 370.

FIG. 4A illustrates some embodiments of the nozzle 400a in which the port outlet 402 is located at about the center of the outlet face 401, but the port inlet center 441 is offset perpendicular from central symmetric axis 421, along the inlet face 431, by an inlet offset 443. As shown, the fluid nozzle 400a includes the first angle 425 formed between the port axis 423 and the central symmetric axis 421. The port outlet face 406 of the port outlet 402 is perpendicular to the port axis 423 and adjacent to the outlet face 401, and at the second angle 427 to the outlet face 401. The second angle 427 is about the same as the first angle 425. In this embodiment, the first angle 425 is between about 0.25° and 10°, for example, about 2° to about 6°. In this embodiment the inlet offset 443 is between about 0.5 mm and about 10 mm, for example 5 mm.

FIG. 4B illustrates some embodiments of the nozzle 400b in which the port outlet 402 is offset from the center of the outlet face 401, but the port inlet 433 is located at about the center of the inlet face 431. As shown, the fluid nozzle 400b includes the first angle 425 formed between the port axis 423 and the central symmetric axis 421. In this embodiment the port inlet 433 is located at about the center of the inlet face 431, but the port outlet center 445 is offset perpendicular to from central symmetric axis 421 along the outlet face 401, by an outlet offset 447. In this embodiment, the first angle is between about 0.25° and 10°, for example, about 2° to about 6°. In this embodiment the outlet offset 447 is between about 1 mm and about 10 mm, for example 3 mm.

FIG. 4C illustrates some embodiments of the nozzle 400c in which the port outlet 402 is offset from the center of the outlet face 401, and the port inlet 433 is offset from the center of the inlet face 431. In this embodiment, the port outlet center 445 is offset from the central symmetric axis 421 by an outlet offset 447, and the port inlet center 441 is offset from the central symmetric axis 421 by an inlet offset 443. The port outlet face 406 of the port outlet 402 is perpendicular to the port axis 423 and adjacent to the outlet face 401, and at a second angle 427 to the outlet face 401. In this embodiment, the first angle is between about 0.25° and about 20°, or between about 0.25° and about 10°, or between about 10° and about 20°. In this embodiment the inlet offset 443 is between about 0.5 mm and about 15 mm, for example 7 mm and the outlet offset 447 is between about 0.5 mm and about 15 mm, for example 7 mm. By offsetting the port inlet 433 and port outlet 402 from the central symmetric axis 421, a larger angle θ can be achieved such that the single nozzle 400c can cover a target range as large a 100 mm.

FIG. 4D illustrates some embodiments of the nozzle 400d in which the port outlet 402 is offset from the center of the outlet face 401, the inlet 433 is offset from the center of the inlet face 431, and the port axis 423 is about parallel with central symmetric axis 421. The port outlet center 445 and port inlet center 441 are both about equally offset an offset distance 443, 447 from central symmetric axis 421 by an outlet offset 447, and inlet offset 443. The inlet offset 443 and the outlet offset 447 are between about 0.5 mm and about 15 mm, for example 7 mm. In this embodiment the stream 370 target can be adjusted by for very precise applications.

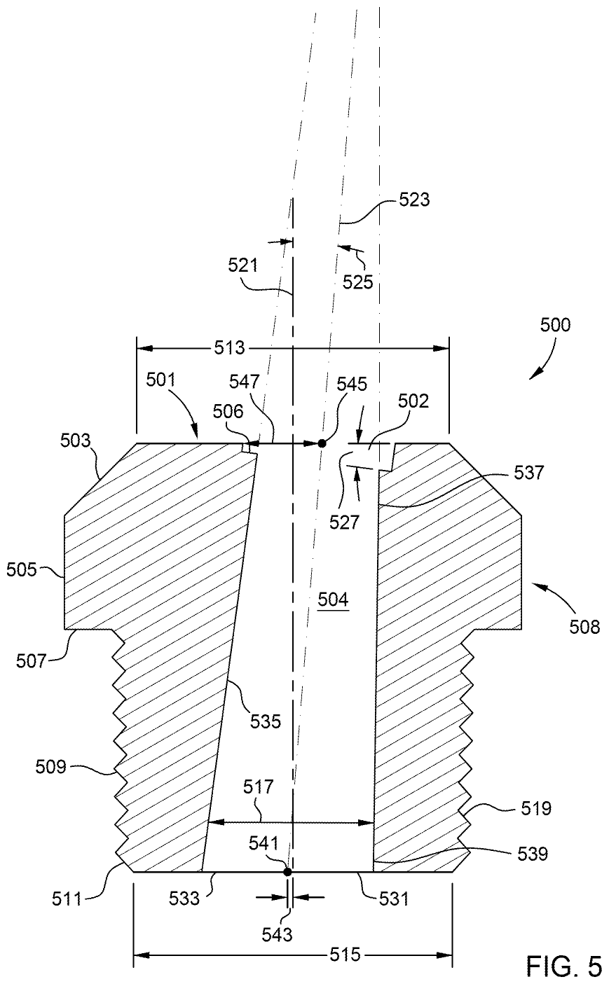

FIG. 5 illustrates some embodiments of a nozzle 500 that can be the nozzle 358 (FIG. 3A, 3B). The nozzle 500 has a port 504 with a port profile 535. Similar to the previous nozzle 400, nozzle 500 includes an outlet face 501 with a port outlet 502 and an inlet face 531. The outlet face 501 has an outlet face diameter 513 between about 3 mm and about 25 mm, for example 20 mm. In some embodiments, the outlet face 501 has an outlet face diameter 513 between about 10 mm and about 35 mm, for example, 31 mm. The inlet face 531 has an inlet face diameter 515 between about 3 mm and about 25 mm, for example 20 mm. In some embodiments, the inlet face 531 has an inlet face diameter 515 between about 10 mm and about 35 mm, for example, 31 mm. The fluid nozzle 500 also includes a nozzle body 507, a threaded region 509, a central symmetric axis 521, a securing region 508 that includes a securing feature 505, and a first angle 525 formed between the port axis 523 and the central symmetric axis 521. In some embodiments the first angle 525 is between about 0.25° and about 20°, or between about 0.25° and about 10°, or between about 10° and about 20°. The port 504 includes a port outlet face 506 within the port outlet 502. The port outlet face 506 is perpendicular to the port axis 523 and adjacent to the outlet face 501, and at a second angle 527 to the outlet face 501. The nozzle 500 also includes a port outlet diameter 537 and a port inlet diameter 539. The port inlet diameter 539 is between about 0.3 mm and about 2.5 mm, for example 1 mm. The port outlet diameter 537 is the diameter of the port outlet 502 perpendicular to the port axis 523. The port outlet diameter 537 is between about 0.3 mm and about 2.5 mm, for example 1 mm.

The port 504 extends along the port axis 523 and through the nozzle body 507, passing through the inlet face 531 and an outlet face 501. According to some embodiments, the port 504 of the nozzle 500 is not uniform and includes the port profile 535. In some embodiments, the port profile 535 is a tapered profile where the port inlet diameter 539 is greater than the port outlet diameter 537 and the profile 535 decreases in a linear trend. In some embodiments, the port profile 535 is a curved profile where the port outlet diameter 537 is less than the port inlet diameter 539 and the profile 535 decreases in a concave curve. In some embodiments the port profile 535 is a curved profile where the port outlet diameter 537 is less than the port inlet diameter 539 and the profile 535 decreases in a convex curve. The profile 535 improves the hydrodynamics of the stream 370 and improves the velocity of the stream 370.

The adjustable fluid nozzle is an improvement that enables tuning of a cleaning operation to specifically target the gap in the carrier head. The ability to quickly adjust the fluid nozzle mitigates the need to have specific load cup configuration to clean portions of a carrier head. The favorable combination of adjustability and characteristics for penetrative cleaning of the carrier head, lower costs, and increase manufacturing output.

While the foregoing is directed to implementations of the present disclosure, other and further implementations of the disclosure may be devised without departing from the basic scope thereof, and the scope thereof is determined by the claims that follow.

What is claimed is:

1. A fluid nozzle for use in a chemical mechanical polishing (CMP) system, comprising:
a nozzle body disposed between an inlet face and an outlet face, the nozzle body comprising:
a threaded region disposed between the inlet face and the outlet face;
a central symmetric axis extending through the nozzle body between the inlet face and the outlet face; and
a port extending along a port axis and through the nozzle body, wherein:
the port axis extends through the nozzle body between the inlet face and the outlet face,
a first angle is formed between the port axis and the central symmetric axis, and
a port outlet face is perpendicular to the port axis, adjacent to the outlet face, and at a second angle to the outlet face.

2. The fluid nozzle of claim 1, wherein the nozzle body further comprises a material comprising PEEK.

3. The fluid nozzle of claim 1, wherein the port comprises a port inlet on the inlet face and a port outlet adjacent to the port outlet face.

4. The fluid nozzle of claim 1, wherein the nozzle body further comprises a securing region with a securing feature.

5. The fluid nozzle of claim 3, wherein the port outlet is offset an outlet offset from the central symmetric axis.

6. The fluid nozzle of claim 3, wherein the port inlet has a diameter between about 1 mm and 5 mm.

7. The fluid nozzle of claim 5, wherein the port inlet is offset an inlet offset distance from the central symmetric axis.

8. The fluid nozzle of claim 1, wherein the first angle is between about 0.25° and about 10°.

9. The fluid nozzle of claim 1, the first angle is between about 10° and 20°.

10. The fluid nozzle of claim 4, wherein the securing feature is a hex pattern.

11. The fluid nozzle of claim 1, further comprising a securing feature that enables tool-less rotation of the nozzle body.

12. The fluid nozzle of claim 1, wherein a port inlet diameter is greater than a port outlet diameter.

13. The fluid nozzle of claim 12, wherein the port outlet diameter is between about 0.3 mm and about 2.5 mm.

14. The fluid nozzle of claim 1, wherein the port further comprises a tapered profile.

15. A fluid nozzle for use in a chemical mechanical polishing (CMP) system, comprising:
a nozzle body disposed between an inlet face and an outlet face, the inlet face, comprising a port inlet, the nozzle body comprising:
a threaded region disposed adjacent to the inlet face;
a securing region disposed between the outlet face and the threaded region;
a central symmetric axis extending through the nozzle body between the inlet face and the outlet face; and
a port extending along a port axis and through the nozzle body, wherein:
the port axis extends through the nozzle body between the inlet face and the outlet face,
a first angle is formed between the port axis and the central symmetric axis, and
a port outlet face is perpendicular to the port axis, adjacent to the outlet face, and at a second angle to the outlet face, the port outlet face comprising an outlet.

16. The fluid nozzle of claim 15, wherein the nozzle body further comprises a material comprising PEEK.

17. The fluid nozzle of claim 15, wherein the outlet is offset a distance from the central symmetric axis and the central symmetric axis is parallel to the port axis.

18. The fluid nozzle of claim 15, wherein the first angle is between about 0.25° and 20°.

19. The fluid nozzle of claim 15, wherein the securing region comprises a hex pattern.

20. A fluid nozzle for use in a chemical mechanical polishing (CMP) system, comprising:
a nozzle body disposed between an inlet face and an outlet face, the nozzle body comprising:
a threaded region disposed between the inlet face and the outlet face;
a central symmetric axis extending through the nozzle body between the inlet face and the outlet face; and
a port extending along a port axis and through the nozzle body, wherein:
the port axis is parallel to and offset from the central symmetric axis,
the port axis extends through the nozzle body between the inlet face and the outlet face, and
the port has a port outlet face perpendicular to the port axis and adjacent to the outlet face.
